(19) United States
(12) Patent Application Publication
(10) Pub. No.: US 2006/0208966 A1
(43) Pub. Date: Sep. 21, 2006

(54) Drive circuit and plasma display device

(75) Inventors: Tetsuya Sakamoto, Kawasaki (JP); Makoto Onozawa, Yokohama (JP); Tomokatsu Kishi, Yamato (JP); Shigetoshi Tomio, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/358,035

(22) Filed: Feb. 22, 2006

(30) Foreign Application Priority Data
Feb. 22, 2005 (JP) 2005-046201

(51) Int. Cl. G09G 3/28

(52) U.S. Cl. 345/60

(57) ABSTRACT

There is provided a drive circuit including: a first signal line connectable to a capacitive load; a second signal line connectable to the capacitive load; a first switch connected between the first signal line and a first potential; a second switch connected between the first signal line and a second potential; a capacitor connected between the first and second signal lines; a third switch connected between the second signal line and the second potential; and a coil circuit connected between at least one of the first and second signal lines and the second potential. At least one of the second switch and the third switch has a configuration in which plural n-channel field-effect transistors are connected in series.

### CROSS-REFERENCE TO RELATED APPLICATIONS

This application is based upon and claims the benefit of priority from the prior Japanese Patent Application No. 2005-046201, filed on Feb. 22, 2005, the entire contents of which are incorporated herein by reference.

### BACKGROUND OF THE INVENTION

1. Field of the Invention The present invention relates to a drive circuit and a plasma display device.

2. Description of the Related Art

FIG. 2 is a circuit diagram of a drive circuit of a plasma display device described in FIG. 4 in the following patent document 1. The drive circuit applies a predetermined voltage to a capacitive load 20. Coil circuits A, A′, B, and B′ constitute, together with the capacitive load 20, an energy recovery circuit. The suppression of oscillation of the coil circuits A, A′, B, and B is carried out using respective switches SW2, SW3, SW2′, and SW3′. Therefore, in order to prevent a reverse current to a power supply circuit, the switches SW2, SW3, SW2′, and SW3′ need high withstanding voltage and high speed, high-current diodes 201, 202, 203, 204, 201′, 202′, 203′, and 204′ therein respectively.

[Patent document 1] International Publication No. 2004/032108 Pamphlet

Use of the high withstanding voltage and high-speed, high-current diodes 201 to 204 and 201′ to 204′ increases the number of parts, increases the area occupied by the circuits, and causes the cost to increase.

### SUMMARY OF THE INVENTION

An object of the present invention is to provide a drive circuit and a plasma display device capable of reducing the number of high withstanding voltage and high speed, high current diodes.

According to an aspect of the present invention, there is provided a drive circuit of a matrix type flat display device that applies a voltage to a capacitive load to be a display unit, the drive circuit including: a first signal line connectable to the capacitive load; a second signal line connectable to the capacitive load; a first switch connected between the first signal line and a first potential; a second switch connected between the first signal line and a second potential; a capacitor connected between the first and second signal lines; a third switch connected between the second signal line and the second potential; and a coil circuit connected between at least one of the first and second signal lines and the second potential. At least one of the second switch and the third switch has a configuration in which plural n-channel field-effect transistors are connected in series.

### BRIEF DESCRIPTION OF THE DRAWINGS

FIG. 1 is a circuit diagram showing a configuration example of an X-side drive circuit and a Y-side drive circuit according to a first embodiment of the present invention.

FIG. 2 is a circuit diagram of a drive circuit of a plasma display device according to the prior art.

FIG. 3 is a waveform diagram showing an operation example during a sustained period of the drive circuit shown in FIG. 1.

FIG. 4 is a diagram showing examples of voltage waveforms of an address electrode Aj, an X electrode Xi, and a Y electrode Yi in a sub-frame of an image.

FIG. 5 is a circuit diagram showing a configuration example of an X-side drive circuit and a Y-side drive circuit according to a second embodiment of the present invention.

FIG. 6 is a waveform diagram showing an operation example during a sustained period of the drive circuit shown in FIG. 5.

FIG. 7 is a diagram showing examples of voltage waveforms of an address electrode Aj, X electrodes X1 and X2, and Y electrodes Y1 and Y2 in a sub-frame of an image.

FIG. 8 is a circuit diagram showing a configuration example of an X-side drive circuit and a Y-side drive circuit according to a third embodiment of the present invention.

FIG. 9 is a circuit diagram showing a configuration example of an X-side drive circuit and a Y-side drive circuit according to a fourth embodiment of the present invention.

FIG. 10 is a waveform diagram showing an operation example during a sustained period of the drive circuit shown in FIG. 9.

FIG. 11 is a circuit diagram showing a configuration example of an X-side drive circuit and a Y-side drive circuit according to a fifth embodiment of the present invention.

FIG. 12 is a circuit diagram showing a configuration example of an X-side drive circuit and a Y-side drive circuit according to a sixth embodiment of the present invention.

FIG. 13 is a circuit diagram showing a configuration example of an X-side drive circuit and a Y-side drive circuit according to a seventh embodiment of the present invention.

FIG. 14 is a circuit diagram showing a configuration example of an X-side drive circuit and a Y-side drive circuit according to an eighth embodiment of the present invention.

FIG. 15 is a diagram showing a configuration example of an AC drive type plasma display device according to the first embodiment of the present invention.

FIG. 16 is a diagram showing a configuration example of an AC drive type plasma display device according to the second embodiment of the present invention.

FIGS. 17A to 17C are diagrams showing sectional configuration examples of a display cell.

### DETAILED DESCRIPTION OF THE PREFERRED EMBODIMENTS

(First Embodiment)

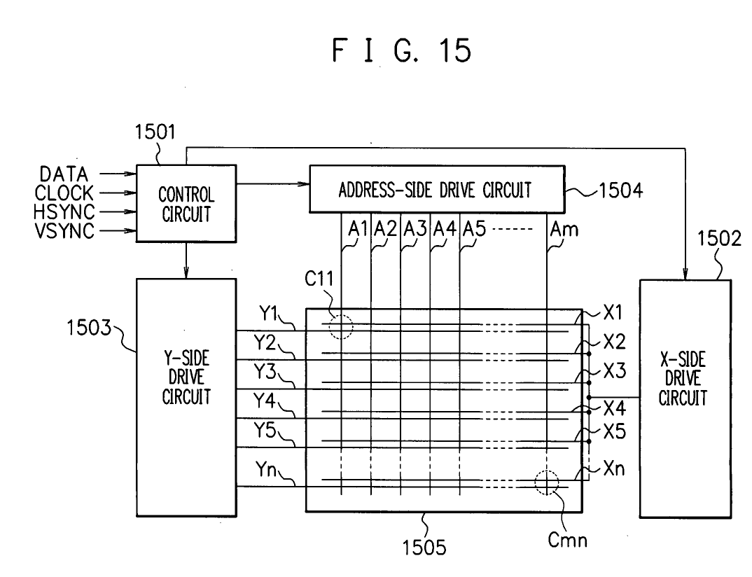

FIG. 15 is a diagram showing a configuration example of an AC drive type plasma display device according to a first embodiment of the present invention. A control circuit 1501 receives an image data DATA, a clock CLOCK, a horizontal synchronization signal HSYNC, and a vertical synchronization signal VSYNC, and controls an X-side drive circuit 1502, a Y-side drive circuit 1503, and an address-side drive circuit 1504. The X-side drive circuit 1502 supplies the same voltage to plural X electrodes X1, X2, . . . . Hereinafter, each of the X electrodes X1, X2, . . . , is referred to as, or all of them are together referred to as, an X electrode Xi, where i means a subscript. The Y-side drive circuit 1503 supplies predetermined voltages to plural Y electrodes Y1, Y2, . . . , respectively. Hereinafter, each of the Y electrodes Y1, Y2, . . . , is referred to as, or all of them are together referred to as, a Y electrode Yi, where i means a subscript. The address-side drive circuit 1504 supplies predetermined voltages to plural address electrodes Al, A2, . . . , respectively. Hereinafter, each of the address electrodes Al, A2, . . . , is referred to as, or all of them are together referred to as, an address electrode Aj, where j means a subscript.

In a plasma display panel 1505, the Y electrode Yi and the X electrode Xi form rows extending in parallel in the horizontal direction and the address electrode Aj forms a column extending in the vertical direction. The Y electrode Yi and the X electrode Xi are arranged alternately in the vertical direction. The Y electrode Yi and the address electrode Aj form an i-row, j-column two-dimensional matrix. A display cell Cij is formed of an intersection of the Y electrode Yi and the address electrode Aj and the adjoining X electrode Xi corresponding thereto. The display cell Cij corresponds to a pixel and a plasma display panel 1505 is capable of displaying a two-dimensional image. The X electrode Xi and the Y electrode Yi in the display cell Cij form a space therebetween and constitute a capacitive load.

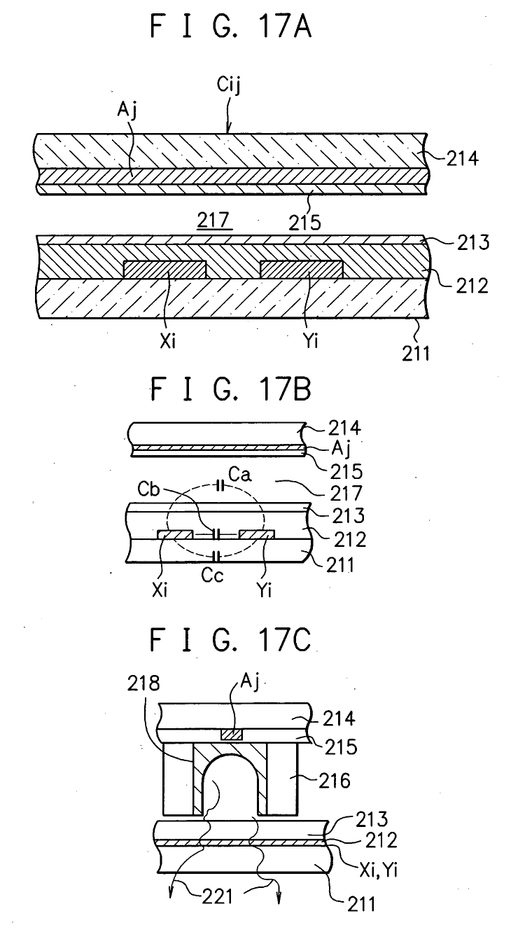

FIG. 17A is a diagram showing a sectional configuration example of the display cell Cij in Fig. 15. The X electrode Xi and the Y electrode Yi are formed on a front surface glass substrate 211. A dielectric layer 212 for insulating a discharge space 217 is adhered thereon, and further, an MgO (magnesium oxide) protective film 213 is adhered thereon.

On the other hand, the address electrode Aj is formed on a back surface glass substrate 214 arranged facing the front surface glass substrate 211, a dielectric layer 215 is adhered thereon, and further, phosphors are adhered thereon. Into the discharge space 217 between the MgO protective film 213 and the dielectric film 215, a Ne+Xe Penning gas etc. is sealed.

FIG. 17B is a diagram for explaining a capacitance Cp of an AC drive type plasma display panel. A capacitance Ca is the capacitance of the discharge space 217 between the X electrode Xi and the Y electrode Yi. A capacitance Cb is the capacitance of the dielectric layer 212 between the X electrode Xi and the Y electrode Yi. A capacitance Cc is the capacitance of the front surface glass substrate 211 between the X electrode Xi and the Y electrode Yi. The panel capacitance Cp between the electrodes Xi and Yi is determined by the sum of the capacitances Ca, Cb, and Cc.

FIG. 17C is a diagram for explaining light emission of an AC drive type plasma display. To the inner surface of ribs 216, red, blue, and green phosphors 218 are applied in a stripe-shaped arrangement for each color. The phosphors 218 are excited by a discharge between the X electrode Xi and the Y electrode Yi to generate light 221.

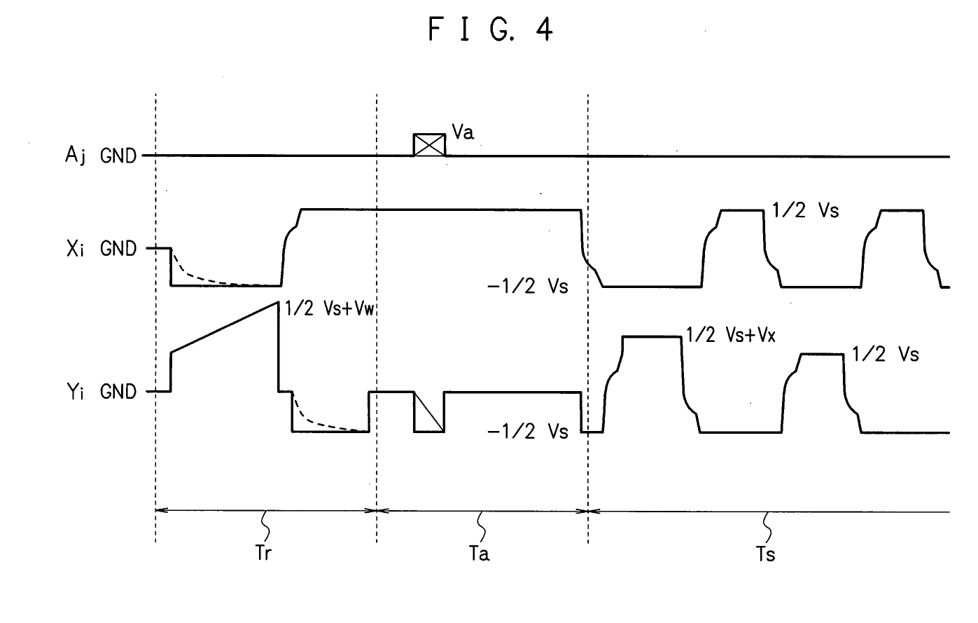

FIG. 4 is a diagram showing voltage waveform examples of the address electrode Aj, the X electrode Xi, and the Y electrode Yi in a sub-frame of an image. One frame is composed of plural sub-frames. Each sub-frame is composed of a reset period Tr, an address period Ta, and a sustained (sustain discharge) period Ts. In the reset period Tr, initialization of the display cell Cij is performed. In the address period Ta, it is possible to select between light emission and non-light emission of each display cell Cij by an address discharge between the address electrode Aj and the Y electrode Yi. Specifically, by applying negative scan pulses sequentially to the Y electrodes Y1, Y2, Y3, Y4, . . . , and applying address pulses Va to the address electrode Aj in accordance with the scan pulses, it is possible to select light emission of a desired display cell Cij. In the sustained period Ts, a sustain pulse in an opposite phase is supplied to the X electrode Xi and the Y electrode Yi of the selected display cell Cij. A sustain discharge is caused to emit light each time a voltage Vs is applied between the X electrode Xi and the Y electrode Yi.

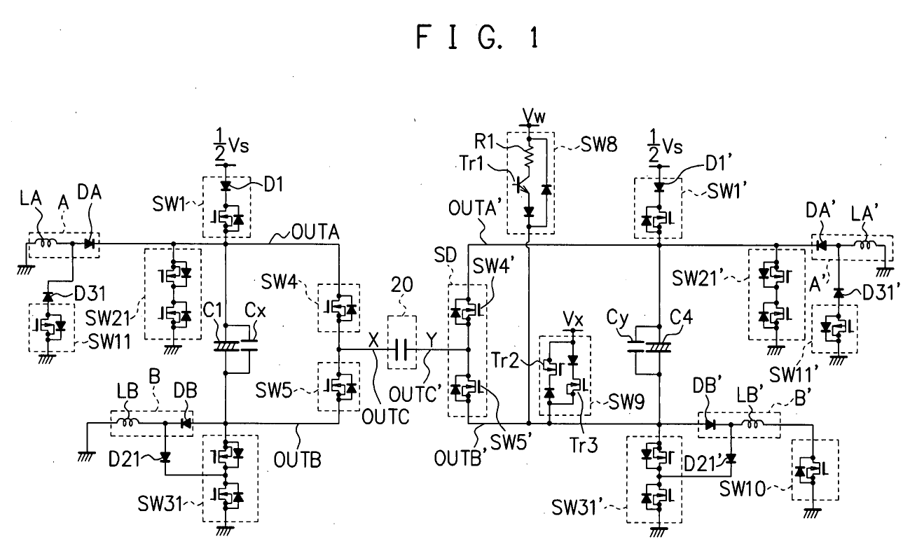

FIG. 1 is a circuit diagram showing a configuration example of the X-side drive circuit 1502 and the Y-side drive circuit 1503 according to the present embodiment. The capacitive load 20 is composed of the X electrode X, the Y electrode Y, and the dielectric in between. The X-side drive circuit 1502 applies a predetermined voltage to the X electrode X. The Y-side drive circuit 1503 applies a predetermined voltage to the Y electrode Y.

Hereinafter, a MOS field effect transistor is simply referred to as a transistor. Every n-channel transistor has a parasitic diode, and the anode of the parasitic diode is connected to the source and the cathode of the parasitic diode is connected to the drain. Every p-channel transistor also has a parasitic diode, and the anode of the parasitic diode is connected to the drain and the cathode of the parasitic diode is connected to the source.

First, the X-side drive circuit is explained. A switch SW4 is composed of an n-channel transistor and connected between signal lines OUTA and OUTC. The signal line OUTC is connected to the X electrode X. The signal line OUTA can be connected to the capacitive load 20. A switch SW5 is composed of an n-channel transistor and connected between signal lines OUTB and OUTC. The signal line OUTB can also be connected to the capacitive load 20. Capacitors C1 and Cx are connected between the signal lines OUTA and OUTB.

A switch SW1 is an n-channel transistor and diode D1 connected in series and connected between the signal line OUTA and a potential +Vs/2 (a first potential). The anode of the diode D1 is connected to the potential +Vs/2 side and the cathode is connected to the signal line OUTA side.

A switch SW21 has a configuration in which the drains of two n-channel transistors are connected in series and is connected between the signal line OUTA and a ground potential (a second potential). The coil circuit A has a configuration in which a coil LA and a diode DA are connected in series and is connected between the signal line OUTA and the ground potential. The cathode of the diode DA is connected to the signal line OUTA. The coil LA is connected between the anode of the diode DA and the ground potential. A switch SW11 is composed of a p-channel transistor and connected between the anode of the diode DA and the ground potential. A diode D31 is connected to the switch SW11 in series and the anode is connected to the ground potential side and the cathode is connected to the anode side of the diode DA.

A switch SW31 has a configuration in which the drains of two n-channel transistors are connected in series and is connected between the signal line OUTB and the ground potential. The coil circuit B has a configuration in which a coil LB and a diode DB are connected in series and is connected between the signal line OUTA and the ground potential. The anode of the diode DB is connected to the signal line OUTB. The coil LB is connected between the cathode of the diode DB and the ground potential. The anode of a diode 21 is connected to the cathode of the diode DB and the cathode is connected to the interconnection point of the drains of the n-channel transistors of the switch 31.

Next, the Y-side drive circuit is explained. The Y-side drive circuit has a configuration similar to that of the X-side drive circuit. A switch SW4′ is composed of an n-channel transistor and connected between signal lines OUTA′ and OUTC′. The signal line OUTC′ is connected to the Y electrode Y. The signal line OUTA′ can be connected to the capacitive load 20. A switch SW5′ is composed of an n-channel transistor and connected between a signal line OUTB′and the signal line OUTC′. The signal line OUTB′ can also be connected to the capacitive load 20. Capacitors C4 and Cy are connected between the signal lines OUTA′ and OUTB′.

The switches SW4′ and SW5′ constitute a scan driver SD. The scan drive SD performs switching operation in order to output a scan pulse for the Y electrode Y during the address period Ta in FIG. 4.

A switch SW1′ is an n-channel transistor and a diode D1′ connected in series and connected between the signal line OUTA′ and the potential +Vs/2. The anode of the diode D1′ is connected to the potential +Vs/2 side and the cathode is connected to the signal line OUTA′ side.

A switch SW21′ has a configuration in which the drains of two n-channel transistors are connected in series, and is connected between the signal line OUTA′ and the ground potential. A coil circuit A′has a configuration in which a coil LA′ and a diode DA′ are connected in series and is connected between the signal line OUTA′ and the ground potential. The cathode of the diode DA′ is connected to the signal line OUTA′. The coil LA′ is connected between the anode of the diode DA′ and the ground potential. A switch SW11′ is composed of a p-channel transistor and connected between the anode of the diode DA′ and the ground potential. A diode D31′ is connected to the switch SW11′ in series and its anode is connected to the ground potential side and its cathode is connected to the anode side of the diode DA′.

A switch SW31′ has a configuration in which the drains of two n-channel transistors are connected in series, and is connected between the signal line OUTB′ and the ground potential. The coil circuit B′has a configuration in which a coil LB′ and a diode DB′ are connected in series. The coil circuit B′ and a switch SW10 connected in series are connected between the signal line OUTB′ and the ground potential. The switch SW10 is composed of an n-channel transistor. The anode of the diode DB′ is connected to the signal line OUTB′. The coil LB′ is connected between the cathode of the diode DB′ and the ground potential. The anode of the diode 21′ is connected to the cathode of the diode DB′ and the cathode is connected to the interconnection point of the drains of the n-channel transistors of the switch SW31′.

A switch SW8 includes a resistor R1 and an npn bipolar transistor Tr1, is connected between the signal line OUTB′ and a write potential Vw, and is capable of generating a voltage of the Y electrode Y during the reset period Tr in FIG. 4.

A switch SW9 includes n-channel transistors Tr2 and Tr3, is connected between the signal line OUTB′and a potential Vx, and is capable of generating a voltage of the Y electrode Y during the sustained period Ts in FIG. 4.

A switch SW10 is a switch for preventing voltages Vw and Vx to be applied to the signal line OUTB′during the reset period Tr, the address period Ta, etc., in FIG. 4 from passing through to the ground potential directly.

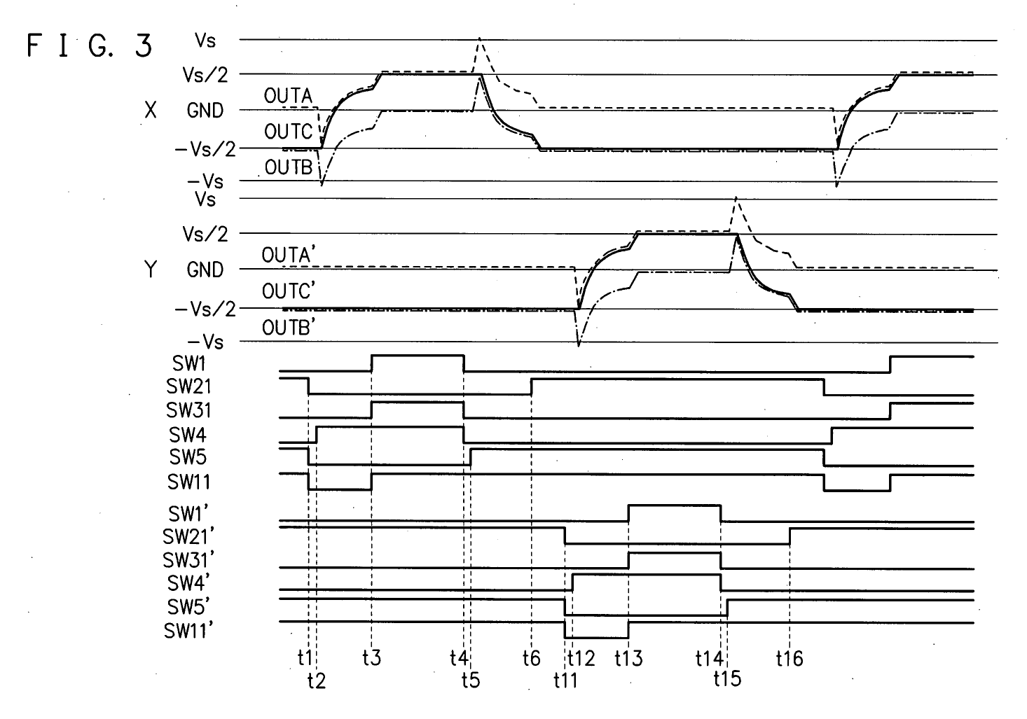

FIG. 3 is a waveform diagram showing an operation example of the drive circuit shown in FIG. 1 during the sustained period Ts (FIG. 4). The voltage waveforms of the signal lines OUTA, OUTB, and OUTC of the X-side drive circuit are shown together. Here, in order to make these voltage waveforms easier-to-see, the voltage waveform of the signal line OUTA is slightly lifted and the voltage waveform of the signal line OUTB is slightly lowered with respect to the voltage waveform of the signal line OUTC in the figure. The signal lines OUTA′, OUTB′, and OUTC′ of the Y-side drive circuit are similarly shown.

Before time t1, the switches SW1, SW1′, SW31, SW31′, SW4, and SW4′ are off and the switches SW21, SW21′, SW5, SW5′, SW11, and SW11′ are on.

A capacitor C1 is charged with the voltage Vs/2. The signal line OUTA is at the ground potential and the signal line OUTB is at a potential −Vs/2. Since the switch SW5 is on, the signal line OUTC is at the potential −Vs/2 as same as the signal line OUTB.

Similarly, the capacitor C4 is charged with the voltage Vs/2. The signal line OUTA′ is at the ground potential and the signal line OUTB′ is at the potential −Vs/2. Since the switch SW5′ is on, the signal line OUTC′ is at the potential −Vs/2 as same as the signal line OUTB′.

At time t1, the switches SW21, SW5, and SW11 are turned off. The signal line OUTC is cut off from the signal line OUTB.

Next, at time t2, the switch SW4 is turned on. The potential −Vs/2 of the signal line OUTC (the X electrode X) accumulated in the capacitive load 20 is transferred to the signal line OUTA via the switch SW4, the potential of the signal line OUTA becomes −Vs/2, and the potential is applied to one terminal of the capacitor C1. Due to this, the potential at the other terminal of the capacitor C1 changes to −Vs and the potential of the signal line OUTB also becomes −Vs.

Then, immediately after time t1, LC resonance occurs between the coil LA and the capacitive load 20. Since the ground potential is connected to the capacitive load 20 via the coil LA and the switch SW4, the potential of the signal lines OUTA and OUTC rises from −Vs/2 toward +Vs/2 through the ground potential. By such a flow of charges, the potential of the signal line OUTC to be applied to the X electrode X gradually rises as shown from time t2 to time t3.

Next, at time t3, before the peak voltage that occurs at the time of resonance is reached, the switches SW1, SW31, and SW11 are turned on. The potential of the signal line OUTC to be applied to the X electrode X is clamped to +Vs/2. By turning the switch SW11 on, the energy between the coil LA and the diode DA is discharged to the ground potential, and thus oscillation is suppressed. Similarly, by turning the switch SW31 on, the energy between the coil LB and the diode DB is discharged to the ground potential, and thus oscillation is suppressed.

Next, at time t4, the switches SW1, SW31, and SW4 are turned off. The signal line OUTC is cut off from the signal line OUTA.

Next, at time t5, the switch SW5 is turned on. The potential +Vs/2 of the signal line OUTC accumulated in the capacitive load 20 is applied to the signal line OUTB via the switch SW5. The potential of the signal line OUTB becomes +Vs/2. Since the capacitor C1 is charged with the voltage Vs/2, the potential of the signal line OUTA becomes +Vs.

Then, immediately after time t5, LC resonance occurs between the coil LB and the capacitive load 20. Since the capacitive load 20 discharges to the ground potential via the coil LB and the switch SW5, the potential of the signal lines OUTB and OUTC falls from +Vs/2 toward −Vs/2 through the ground potential. By such a flow of charges, the potential of the signal line OUTC to be applied to the X electrode X gradually falls as shown from time t5 to time t6.

Next, at time t6, before the peak voltage that occurs at the time of resonance is reached, the switch SW21 is turned on. The potential of the signal line OUTC to be applied to the X electrode X is clamped to −Vs/2.

Next, from time t11 to time t16, the on/off control of the switches SW1′, SW21′, SW31′, SW4′, SW5′, and SW11′ is performed similarly to that of the switches SW1, SW21, SW31, SW4, SW5, and SW11 from time t1 to t6. Due to this, the potentials of the signal lines OUTA′, OUTB′, and OUTC′ from time t11 to time t16 become the same as those of the signal lines OUTA, OUTB, and OUTC from time t1 to t6, respectively. After this, if the operation is performed repeatedly with the period from time t1 to time t16 as one cycle, it is possible to generate voltages of the X electrode and the Y electrode during the sustained period Ts in FIG. 4. Near time t3 and time t13, a dischargeable voltage is applied between the X electrode and the Y electrode, respectively, therefore, a discharge is caused to emit light.

The signal lines OUTC and OUTC′ in FIG. 3 do not have the clamp (sustain) period at the ground level. In other words, in the drive circuit according to the present embodiment, when the sustain operation is performed with the same period, it is possible to extend the time during which the voltage +Vs/2 or the voltage −Vs/2 are sustained, being the top width and the bottom width of a sustain pulse. Due to this, it is possible to ensure more certainly the time for wall charges to move between the X electrode and the Y electrode during the sustained period Ts. Further, it is possible to cause a sustain discharge to occur more stably and therefore, the operating margin can be enlarged and the luminance of the plasma display panel can be improved.

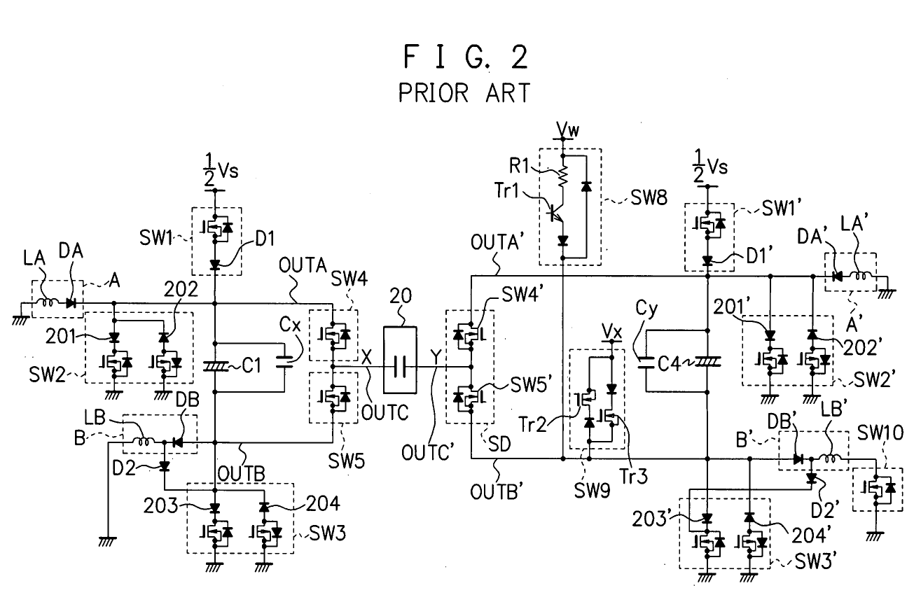

Further, in comparison with the drive circuit in FIG. 2, the high withstanding voltage and high speed, high current diodes 201 to 204 and 201′ to 204′ can be eliminated, reduction therefore becomes possible in the number of parts and in the area occupied by circuits and cost reduction can be achieved.

Note that both the coil circuit A (A′) and the coil circuit B (B′) are not necessarily needed and one of them will do. Further, both of the switches SW21 (SW21′) and SW31 (SW31′) are not necessarily two n-channel transistors connected in series and one of them will do.

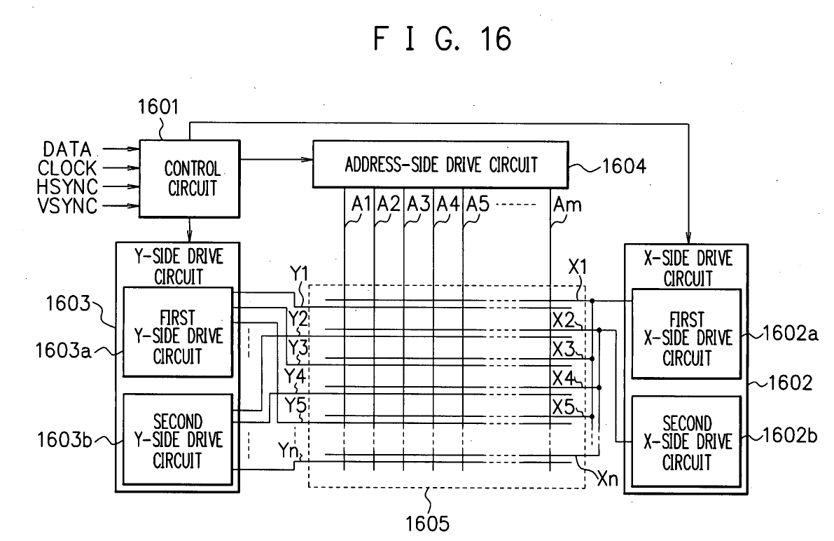

(Second Embodiment) FIG. 16 is a diagram showing a configuration example of an AC drive type plasma display device according to a second embodiment of the present invention. A control circuit 1601 receives the image data DATA, the clock CLOCK, the horizontal synchronization signal HSYNC, and the vertical synchronization signal VSYNC, and controls an X-side drive circuit 1602, a Y-side drive circuit 1603, and an address-side drive circuit 1604. The X-side drive circuit 1602 includes a first X-side drive circuit 1602a and a second X-side drive circuit 1602b. The first X-side drive circuit 1602a supplies the same voltage to odd-numbered X electrodes X1, X3, X5, . . . . The second X-side drive circuit 1602b supplies the same voltage to even-numbered X electrodes X2, X4, X6, . . . . The Y-side drive circuit 1603 includes a first Y-side drive circuit 1603a and a second Y-side drive circuit 1603b. The first Y-side drive circuit 1603asupplies predetermined voltages to odd-numbered Y electrodes Y1, Y3, Y5, . . . . The second Y-side drive circuit supplies predetermined voltages to even-numbered Y electrodes Y2, Y4, Y6, . . . . The address-side drive circuit 1604 supplies predetermined voltages to plural address electrodes A1, A2, . . . . A plasma display panel 1605 is capable of displaying a two-dimensional image as same as in FIG. 15.

In the present embodiment, in an odd frame, a sustain discharge is caused between the electrodes X1 and Y1, between the electrodes X2 and Y2, between the electrodes X3 and Y3, etc., and in an even frame, a sustain discharge can also be caused between the electrodes Y1 and X2, between the electrodes Y2 and X3, between the electrodes Y3 and X4, etc.

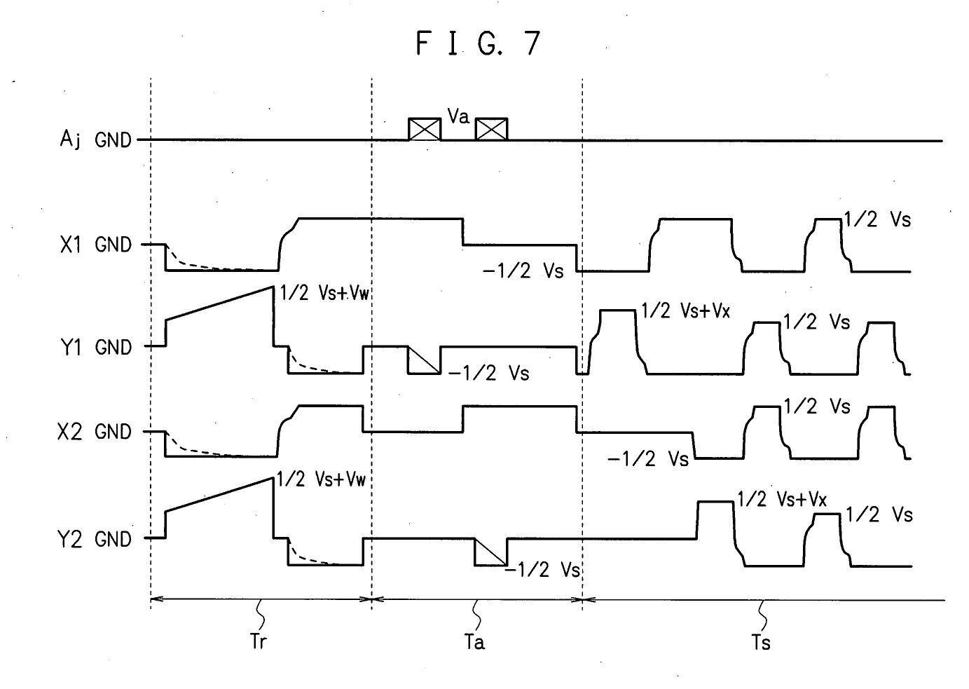

FIG. 7 is a diagram showing voltage waveform examples of the address electrode Aj, the X electrodes X1 and X2, and the Y electrodes Y1 and Y2. One frame is composed of plural sub-frames. Each sub-frame is composed of the reset period Tr, the address period Ta, and the sustained (sustain discharge) period Ts. In the reset period Tr, initialization of the display cell Cij is performed. In the address period Ta, it is possible to select between light emission and non-light emission of each display cell Cij by an address discharge between the address electrode Aj and the Y electrode Yi. Specifically, by applying negative scan pulses sequentially to the Y electrodes Y1, Y2, Y3, Y4, . . . , and an applying address pulse Va to the address electrode Aj in accordance with the scan pulse, it is possible to select light emission of a desired display cell Cij. In the sustained period Ts, a sustain pulse in the opposite phase is supplied to the X electrode Xi and the Y electrode Yi of the selected display cell Cij. A sustain discharge is caused for light emission each time a voltage Vs is applied between the X electrode Xi and the Y electrode Yi.

During the sustained period Ts, the same voltage as that of the X electrode X1 is applied to the odd-numbered X electrodes X1, X3, X5, etc., the same voltage as that of the X electrode X2 is applied to the even-numbered X electrodes X2, X4, X6, etc., the same voltage as that of the Y electrode Y1 is applied to the odd-numbered Y electrodes Y1, Y3, Y5, etc., and the same voltage as that of the Y electrode Y2 is applied to the even-numbered Y electrodes Y2, Y4, Y6, etc.

Further, during the sustained period Ts (excluding the front period), the same voltage is applied to the odd-numbered X electrode X1 and the even-numbered Y electrode Y2 and the same voltage is applied to the odd-numbered Y electrode Y1 and the even-numbered X electrode X2.

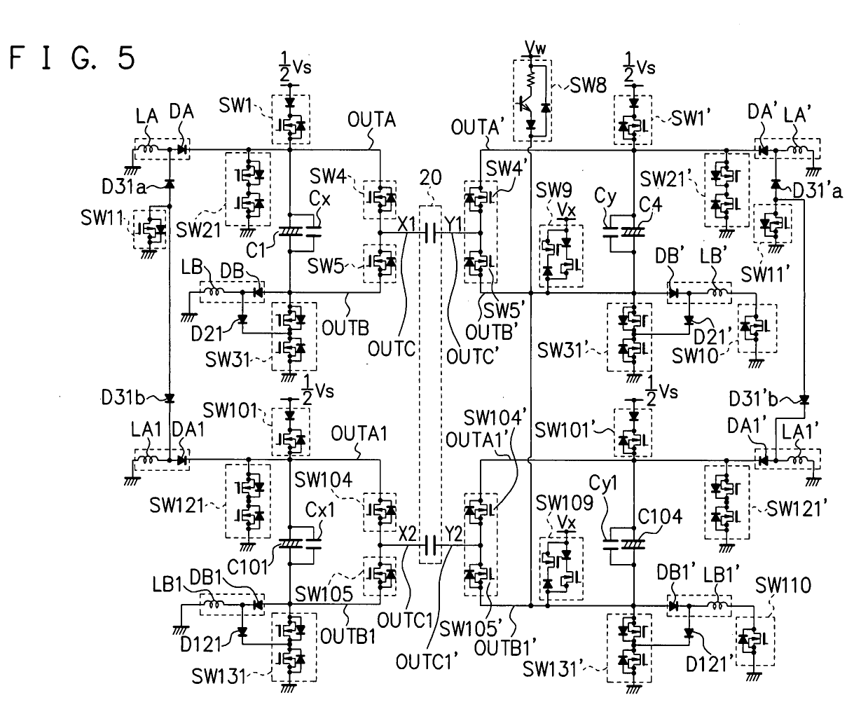

FIG. 5 is a circuit diagram showing a configuration example of the X-side drive circuit 1602 and the Y-side drive circuit 1603 according to the present embodiment. The difference of FIG. 5 from FIG. 1 will be described below. As the capacitive load 20, a load between the X electrode X1 and the Y electrode Y1, and a load between the X electrode X2 and the Y electrode Y2 are shown.

The X-side drive circuit connected to the X electrode X1 and the Y-side drive circuit connected to the Y electrode Y1 are the same as those in FIG. 1. Also, the X-side drive circuit connected to the X electrode X2 and the Y-side drive circuit connected to the Y electrode Y2 are the same as those in FIG. 1.

However, one switch SW11 is shared by the drive circuits of X electrode X1 and X electrode X2. In other words, the cathode of a diode D31a is connected to the anode of the diode DA and the anode is connected to the anode of a diode D31b. The cathode of the diode D31b is connected to the anode of a diode DA1. The switch SW11 is connected between the interconnection point of the anodes of the diodes D31a and D31b and the ground potential.

Similarly, one switch SW11′ is shared by the drive circuits of Y electrode Y1 and Y electrode Y2. In other words, the cathode of a diode D31′a is connected to the anode of the diode DA′ and the anode is connected to the anode of a diode D31′b. The cathode of the diode D31′b is connected to the anode of a diode DA1′. The switch SW11′ is connected between the interconnection point of the anodes of the diodes D31′a and D31′b and the ground potential.

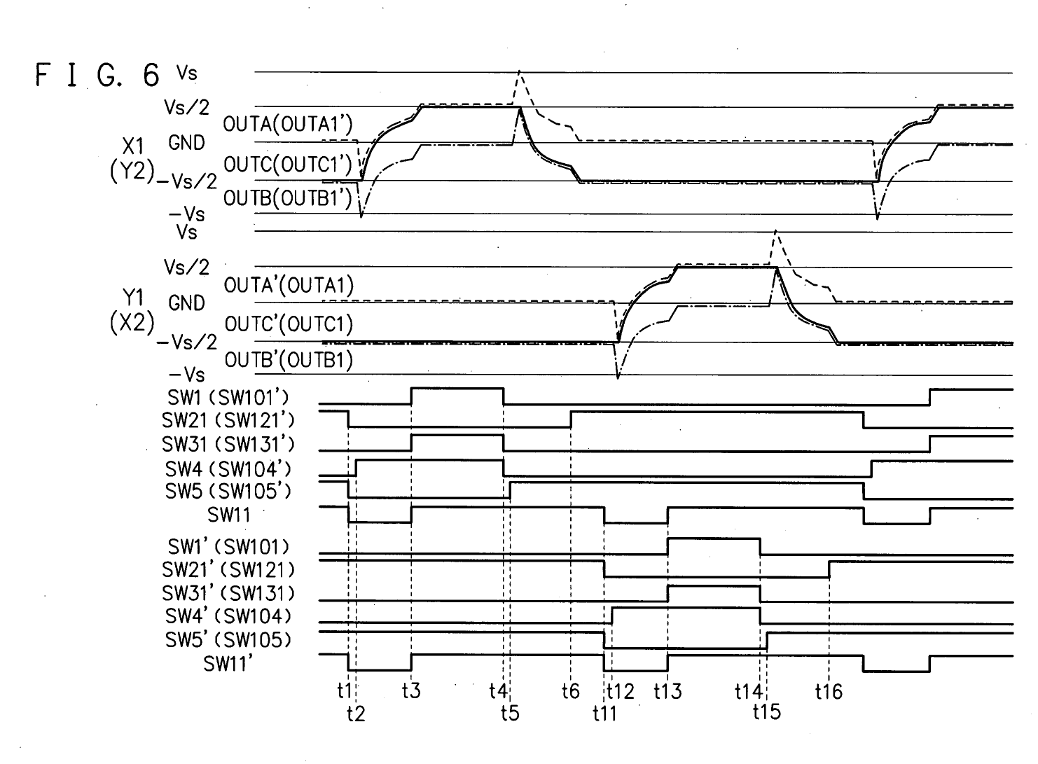

FIG. 6 is a waveform diagram showing an operation example during the sustained period Ts (FIG. 7) of the drive circuit shown in FIG. 5. The difference of FIG. 6 from FIG. 3 is described. The respective potentials of the signal lines OUTA, OUTB, and OUTC of the odd-numbered X electrode X1 are the same as the respective potentials of the signal lines OUTA1′, OUTB1′, and OUTC1′ of the even-numbered Y electrode Y2. Also, the respective potentials of the signal lines OUTA′, OUTB′, and OUTC′ of the odd-numbered Y electrode Y1 are the same as the respective potentials of the signal lines OUTA1, OUTB1, and OUTC1 of the even-numbered X electrode X2.

The on/off control of a switch SW101′ is the same as the switch SW1, that of a switch SW121′ is the same as the switch SW21, that of a switch SW131′ is the same as the switch SW31, that of a switch SW104′is the same as the switch SW4, and that of a switch SW105′ is the same as the switch SW5. Also, the on/off control of a switch SW101 is the same as the switch SW1′, that of a switch SW121 is the same as the switch SW21′, that of a switch SW131 is the same as the switch SW31′, that of a switch SW104 is the same as the switch SW4′, and that of a switch SW105 is the same as the switch SW5′.

Since the switch SW11 is shared by the drive circuits of the X electrode X1 and X electrode X2, it is turned off from time t11 to time t13, in addition, also from time t1 to time t3. Similarly, the switch SW11′ is turned off from time t1 to time t3, in addition, also from time t11 to time t13.

(Third Embodiment)

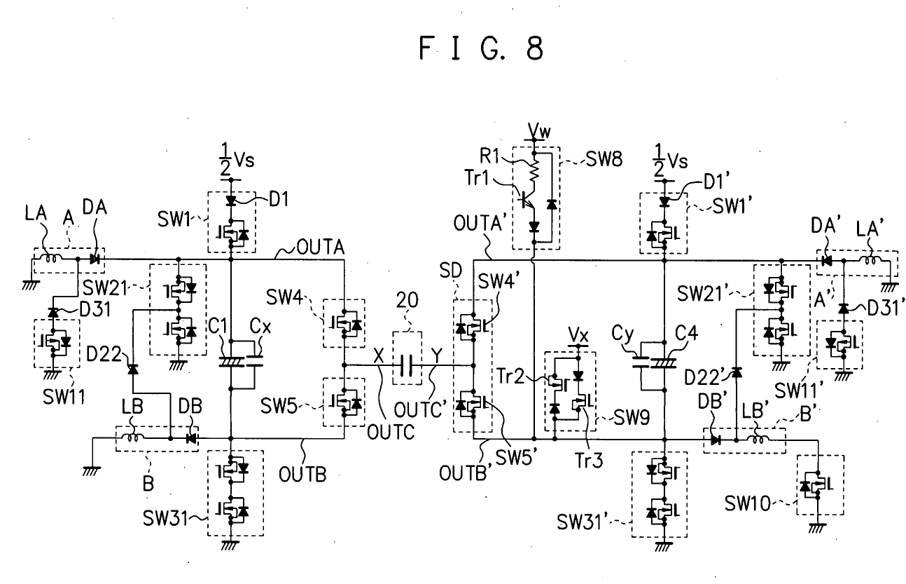

FIG. 8 is a circuit diagram showing a configuration example of the X-side drive circuit 1502 and the Y-side drive circuit 1503 according to a third embodiment of the present invention. The difference of the present embodiment from the first embodiment will be described below. In FIG. 8, the diodes D21 and D21′ are removed and diodes D22 and D22′ are added in FIG. 1. The anode of the diode D22 is connected to the cathode of the diode DB and the cathode is connected to the interconnection point of the drains of the n-channel transistors of the switch 21. The anode of the diode D22′ is connected to the cathode of the diode DB′ and the cathode is connected to the mutual connection point of the drains of the n-channel transistors of the switch 21′. The control of each switch is the same as that in FIG. 3.

(Fourth Embodiment)

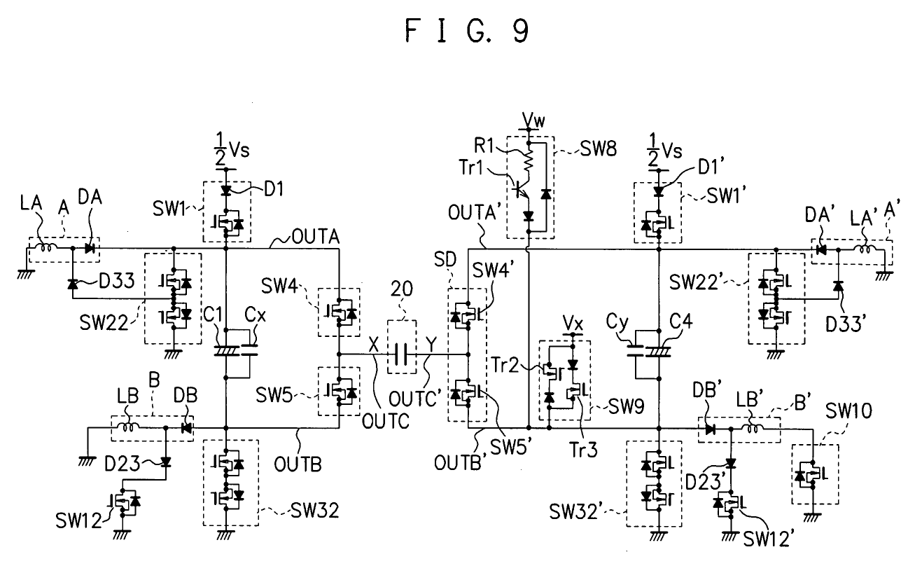

FIG. 9 is a circuit diagram showing a configuration example of the X-side drive circuit 1502 and the Y-side drive circuit 1503 according to a fourth embodiment of the present invention. The difference of the present embodiment from the first embodiment will be described below. In FIG. 9, the switches SW11, SW21, SW31, SW11′, SW21′, and SW31′and the diodes D31, D21, D31′ and D21′ are removed and switches SW22, SW12, SW32, SW22′, SW12′, and SW32′ and diodes D33, D23, D33′, and D23′ are added in FIG. 1.

The switch SW22 has a configuration in which the sources of two n-channel transistors are connected in series and is connected between the signal line OUTA and the ground potential. The anode of the diode D33 is connected to the interconnection point of the sources of the n-channel transistors of the switch 22 and the cathode is connected to the anode of the diode DA.

Similarly, the switch SW22′ has a configuration in which the sources of two n-channel transistors are connected in series and is connected between the signal line OUTA′ and the ground potential. The anode of the diode D33′ is connected to the interconnection point of the sources of the n-channel transistors of the switch 22′ and the cathode is connected to the anode of the diode DA′.

The switch SW32 has a configuration in which the sources of two n-channel transistors are connected in series and is connected between the signal line OUTB and the ground potential. The switch SW12 is composed of an n-channel transistor and connected between the cathode of the diode DB and the ground potential. The diode D23 is connected to the switch 12 in series, and the anode is connected to the cathode side of the diode DB and the cathode is connected to the ground potential side.

Similarly, the switch SW32′ has a configuration in which the sources of two n-channel transistors are connected in series and is connected between the signal line OUTB′ and the ground potential. The switch SW12′ is composed of an n-channel transistor, and connected between the cathode of the diode DB′and the ground potential. The diode D23′ is connected to the switch 12′ in series, and the anode is connected to the cathode side of the diode DB′ and the cathode is connected to the ground potential side.

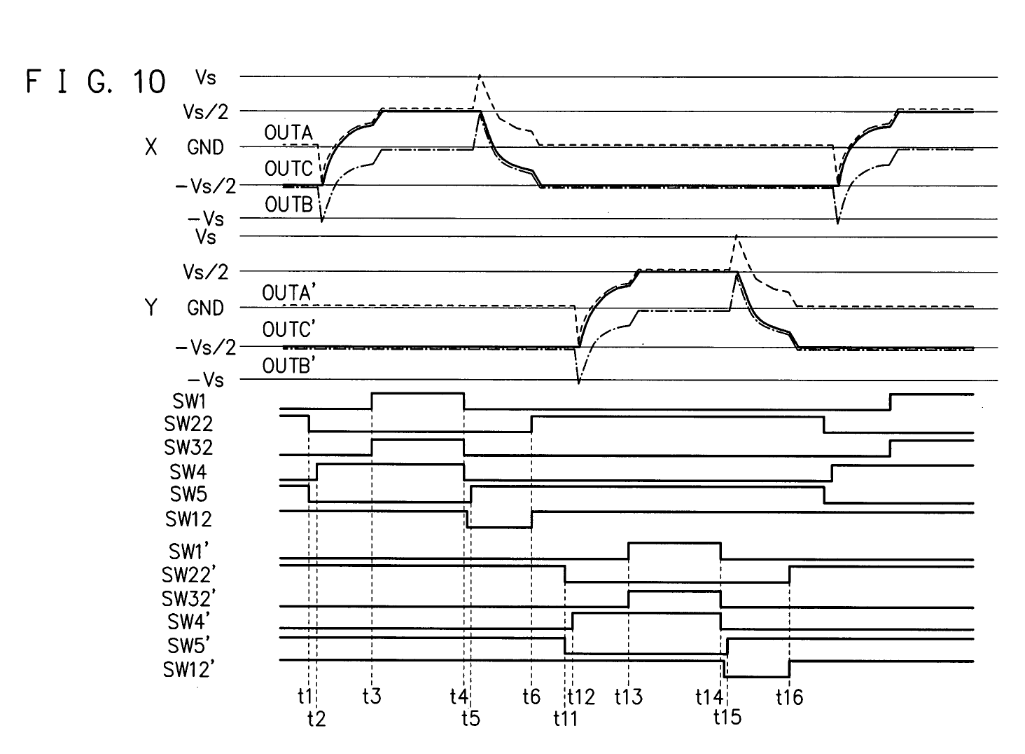

FIG. 10 is a waveform diagram showing an operation example during the sustained period Ts (FIG. 7) of the drive circuit shown in FIG. 9. The difference of FIG. 10 from FIG. 3 is described. The switch SW22 performs the same on/off control as that of the switch SW21 in FIG. 3, the switch SW32 performs the same on/off control as that of the switch SW31 in FIG. 3, the switch SW22′ performs the same on/off control as that of the switch SW21′ in FIG. 3, and the switch SW32′ performs the same on/off control as that of the switch SW31′ in FIG. 3.

The switch SW12 switches from on to off after time t4 and before time t5 and switches from off to on at time t6. By turning on the switch SW12, it is possible to discharge energy between the coil LB and the diode DB to the ground potential to suppress oscillation.

Similarly, the switch SW12′ switches from on to off after time t14 and before time t15 and switches from off to on at time t16. By turning on the switch SW12′, it is possible to discharge energy between the coil LB′ and the diode DB′ to the ground potential to suppress oscillation.

(Fifth Embodiment)

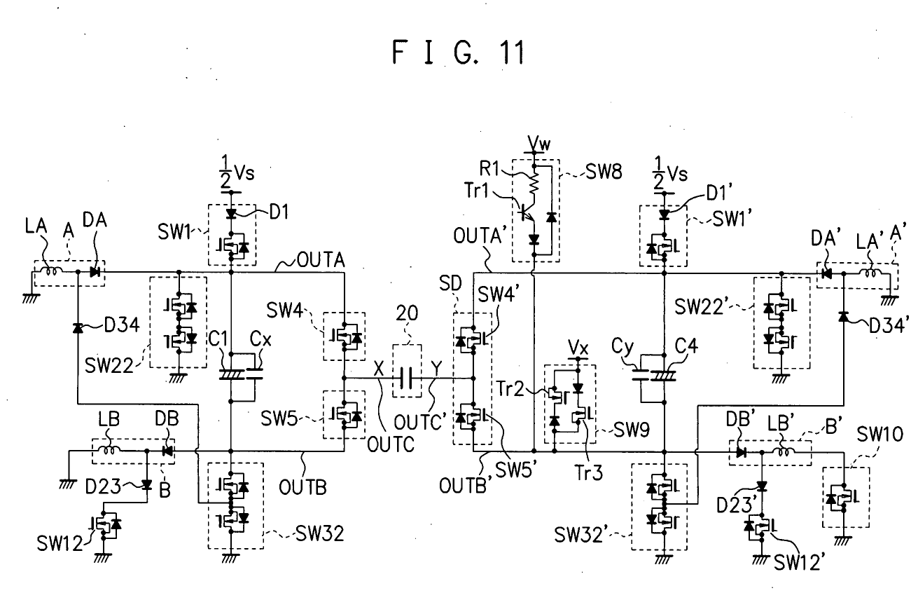

FIG. 11 is a circuit diagram showing a configuration example of the X-side drive circuit 1502 and the Y-side drive circuit 1503 according to a fifth embodiment of the present invention. The difference of the present embodiment from the fourth embodiment will be described below. In FIG. 11, the diodes D33 and D33′ are removed and diodes D34 and D34′ are added in FIG. 9. The anode of the diode D34 is connected to the interconnection point of the sources of the n-channel transistors of the switch SW32 and the cathode is connected to the anode of the diode DA. Similarly, the anode of the diode D34′ is connected to the interconnection point of the sources of the n-channel transistors of the switch SW32′ and the cathode is connected to the anode of the diode DA′. The control of each switch is the same as that in FIG. 10.

(Sixth Embodiment)

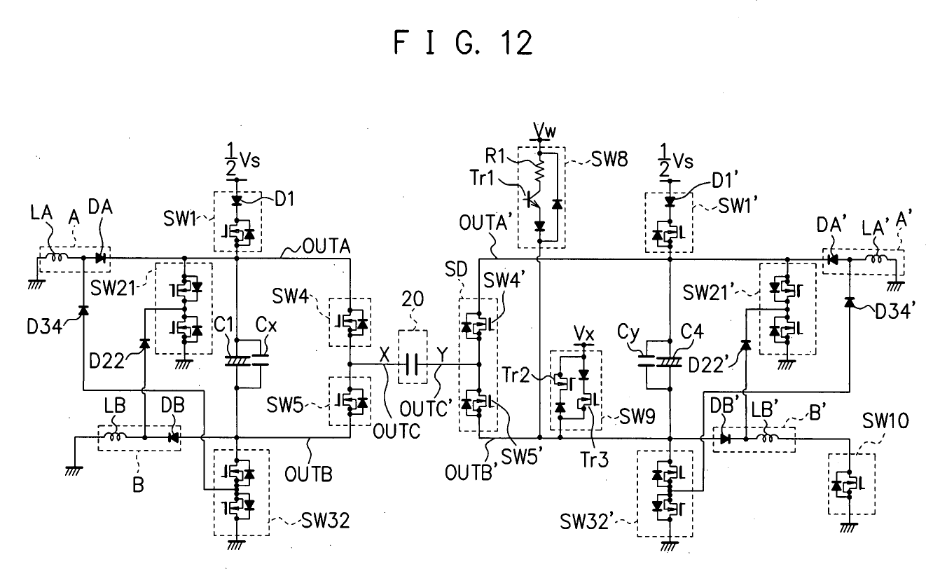

FIG. 12 is a circuit diagram showing a configuration example of the X-side drive circuit 1502 and the Y-side drive circuit 1503 according to a sixth embodiment of the present invention. The difference of the present embodiment from the fifth embodiment will be described below. In FIG. 12, the switches SW12, SW22, SW12′, and SW22′ and the diodes D23 and D23′ are removed and the switches SW21 and SW21′ and the diodes D22 and D22′ are added in FIG. 11.

The switch SW21 has a configuration in which the drains of two n-channel transistors are connected in series and is connected between the signal line OUTA and the ground potential. The anode of the diode D22 is connected to cathode of the diode DB and the cathode is connected to the interconnection point of the drains of the n-channel transistors of the switch 21. Similarly, the switch SW21′ has a configuration in which the drains of two n-channel transistors are connected in series, and is connected between the signal line OUTA′ and the ground potential. The anode of the diode D22′ is connected to the cathode of the diode DB′ and the cathode is connected to the interconnection point of the drains of the n-channel transistors of the switch 21′. The control of each switch is the same as that in FIG. 3.

(Seventh Embodiment)

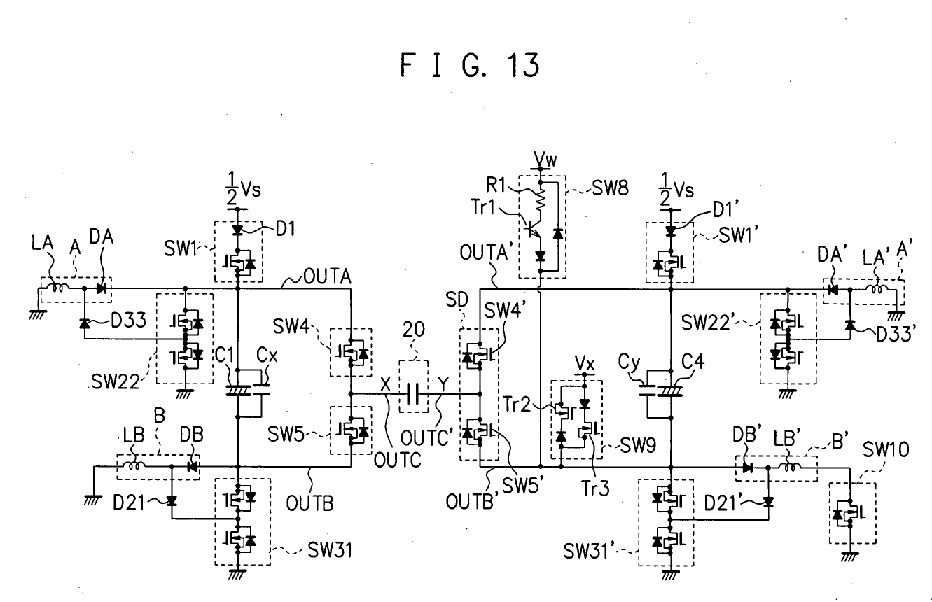

FIG. 13 is a circuit diagram showing a configuration example of the X-side drive circuit 1502 and the Y-side drive circuit 1503 according to a seventh embodiment of the present invention. The difference of the present embodiment from the first embodiment will be described below. In FIG. 13, the switches SW11, SW21, SW11′, and SW21′ and the diodes D31 and D31′ are removed and the switches SW22 and SW22′ and the diodes D33 and D33′ are added in FIG. 1.

The switch SW22 has a configuration in which the sources of two n-channel transistors are connected in series and is connected between the signal line OUTA and the ground potential. The anode of the diode D33 is connected to the interconnection point of the n-channel transistors of the switch SW22 and the cathode is connected to the anode of the diode.DA. Similarly, the switch SW22′ has a configuration in which the sources of two n-channel transistors are connected in series and is connected between the signal line OUTA′ and the ground potential. The anode of the diode D33′ is connected to the interconnection point of the sources of the n-channel transistors of the switch 22′ and the cathode is connected to the anode of the diode DA′. The control of each switch is the same as that in FIG. 3.

(Eighth Embodiment)

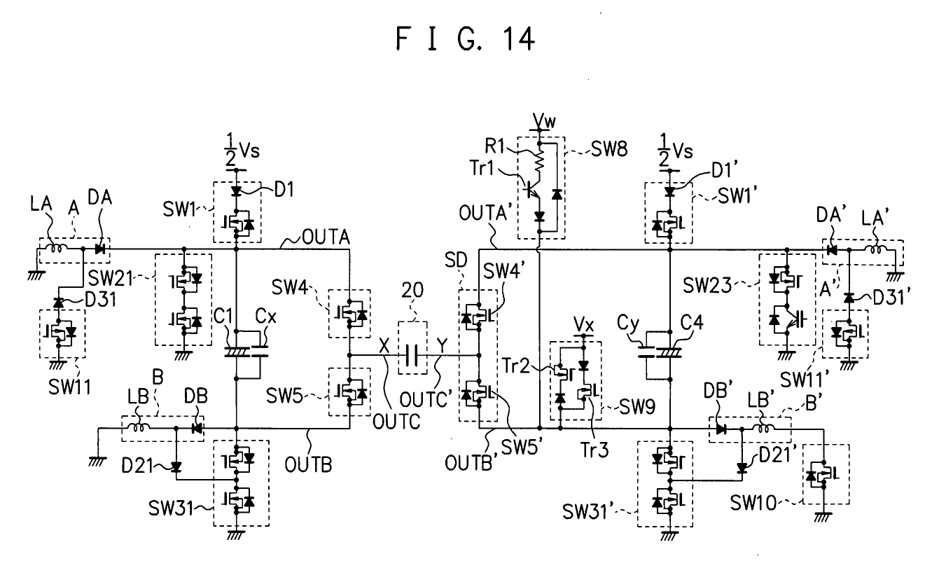

FIG. 14 is a circuit diagram showing a configuration example of the X-side drive circuit 1502 and the Y-side drive circuit 1503 according to an eighth embodiment of the present invention. The difference of the present embodiment from the first embodiment will be described below. In FIG. 14, the switch SW21′ is removed and a switch SW23 is added in FIG. 1. The switch SW23 has a configuration in which a switch and an n-channel transistor are connected in series; the switch being configured such that the cathode of a diode is connected to the collector of an IGBT (Insulated Gate Bipolar Transistor) and the anode of the diode is connected to the emitter of the IGBT, and the switch SW23 is connected between the signal line OUTA′ and the ground potential. In other words, a circuit in which an IGBT and a diode are connected in parallel and an n-channel transistor are connected in series.

The switches SW21, SW22, SW31, SW32, SW21, SW22′, SW31′, and SW32′ in the first to eighth embodiments are described using examples where two n-channel MOS transistors are used, however, one of or both of the two n-channel transistors may be replaced with an IGBT. However, since an IGBT has no parasitic diode, it is necessary to connect a diode separately to the IGBT in parallel. The anode of the diode is connected to the emitter of the IGBT and the cathode is connected to the collector of the IGBT. The collector of the IGBT corresponds to the drain of the n-channel transistor and the emitter corresponds to the source of the n-channel transistor.

That is, the configuration may be one in which a switch and an n-channel transistor are connected in series; the switch being configured such that the cathode of a diode is connected to the collector of an IGBT and the anode of the diode is connected to the emitter of the IGBT, or one in which two switches are connected in series; the switch being configured such that the cathode of a diode is connected to the collector of an IGBT and the anode of the diode is connected to the emitter of the IGBT.

It is possible for the switches SW21, SW31, SW21′, and SW31′ to have a configuration in which the collectors of two IGBTs are connected in series or a configuration in which the collector of an IGBT and the drain of an n-channel transistor are connected in series.

Further, it is possible for the switches SW22, SW32, SW22′, and SW32′ to have a configuration in which the emitters of two IGBTs are connected in series or a configuration in which the emitter of an IGBT and the source of an n-channel transistor are connected in series.

As described above, according to the first to eighth embodiments, switches (parts for small allowable loss) for suppressing oscillation of the coil circuits A, A′, B, and B′ for energy recovery are newly provided. Or, by changing the wiring of a switch in a power supply circuit part, a circuit configuration can be realized, which requires no high withstanding voltage and high speed, high current diode of the power supply circuit part. Specifically, the switch in the power supply circuit part is changed from a parallel connection configuration circuit to a series connection configuration circuit. Since no high withstanding voltage and high speed, high current diode in the power supply circuit part is required, reduction in the number of parts and reduction in the area occupied by circuits become possible and cost reduction can be achieved.

Incidentally, as that in FIG. 5, it is also possible to configure the drive circuits in FIGS. 8, 9, 11, and 14 such that the switches SW11 (SW12) and SW11′ (SW12′) are shared between the drive circuits of the X electrodes X1 and X2 and between the drive circuits of the Y electrodes Y1 and Y2.

The first to eighth embodiments are described with a plasma display device as an example, however, the embodiments are not limited to this, and can be applied to a drive circuit of a matrix type flat display device that applies a voltage to a capacitive load to be a display unit.

The respective embodiments described above merely show examples in which the present invention is embodied and should not be interpreted as those that limit the technical scope of the present invention. In other words, the present invention can be embodied in various ways without departing from the technical idea and its main features.

Since the number of high withstanding voltage and high speed, high current diodes can be reduced, reduction in the number of parts and reduction in the area occupied by circuits become possible and cost reduction can be realized.

What is claimed is:

1. A drive circuit of a matrix type flat display device that applies a voltage to a capacitive load to be a display unit, said drive circuit comprising:
a first signal line connectable to said capacitive load;
a second signal line connectable to said capacitive load;
a first switch connected between said first signal line and a first potential;
a second switch connected between said first signal line and a second potential;
a capacitor connected between said first and second signal lines;
a third switch connected between said second signal line and said second potential; and
a coil circuit connected between at least one of said first and second signal lines and said second potential, wherein at least one of said second switch and said third switch has a configuration in which plural n-channel field-effect transistors are connected in series.

2. The drive circuit according to claim 1, wherein at least one of said second switch and said third switch has a configuration in which drains of two n-channel field-effect transistors are connected in series.

3. The drive circuit according to claim 1, wherein at least one of said second switch and said third switch has a configuration in which sources of two n-channel field-effect transistors are connected in series.

4. The drive circuit according to claim 2, wherein said coil circuit including:
a first diode an anode of which is connected to said second signal line; and
a first coil connected between a cathode of said first diode and said second potential, and wherein said third switch has a configuration in which the drains of two n-channel field-effect transistors are connected in series, and further includes a second diode an anode of which is connected to the cathode of said first diode and a cathode of which is connected to an interconnection point of the drains of the n-channel field-effect transistors of said third switch.

5. The drive circuit according to claim 3, wherein said coil circuit includes:
a first diode a cathode of which is connected to said first signal line; and
a first coil connected between an anode of said first diode and said second potential, and wherein said second switch has a configuration in which the sources of two n-channel field-effect transistors are connected in series, and further includes a second diode a cathode of which is connected to the anode of said first diode and an anode of which is connected to an interconnection point of the sources of the n-channel field-effect transistors of said third switch.

6. The drive circuit according to claim 2, wherein said coil circuit includes:
a first diode a cathode of which is connected to said first signal line;
a first coil connected between an anode of said first diode and said second potential; and further
a fourth switch connected between the anode of said first diode and said second potential.

7. The drive circuit according to claim 3, wherein said coil circuit includes:
a first diode an anode of which is connected to said second signal line;
a first coil connected between a cathode of said first diode and said second potential; and further
a fourth switch connected between the cathode of said first diode and said second potential.

8. A plasma display device comprising:
the drive circuit according to claim 1; and
a plasma display panel having said capacitive load.

9. A drive circuit of a matrix type flat display device that applies a voltage to first and second capacitive loads to be a display unit, said drive circuit comprising:
a first signal line connectable to said first capacitive load;
a second signal line connectable to said first capacitive load;
a first switch connected between said first signal line and a first potential;
a second switch connected between said first signal line and a second potential and having a configuration in which drains of two n-channel field- effect transistors are connected in series;
a first capacitor connected between said first and second signal lines;
a third switch connected between said second signal line and said second potential and having a configuration in which drains of two n-channel field-effect transistors are connected in series;
a first diode a cathode of which is connected to said first signal line;
a first coil connected between an anode of said first diode and said second potential;
a second diode an anode of which is connected to said second signal line;
a second coil connected between a cathode of said second diode and said second potential;
a third signal line connectable to said second capacitive load;
a fourth signal line connectable to said second capacitive load;
a fourth switch connected between said third signal line and said first potential;
a fifth switch connected between said third signal line and said second potential and having a configuration in which drains of two n-channel field-effect transistors are connected in series;
a second capacitor connected between said third and fourth signal lines;
a sixth switch connected between said fourth signal line and said second potential and having a configuration in which drains of two n-channel field-effect transistors are connected in series;
a third diode a cathode of which is connected to said third signal line;
a third coil connected between an anode of said third diode and said second potential;
a fourth diode an anode of which is connected to said fourth signal line; and
a fourth coil connected between a cathode of said fourth diode and said second potential.

10. The drive circuit according to claim 9, further comprising:
a fifth diode a cathode of which is connected to the anode of said first diode;
a sixth diode a cathode of which is connected to the anode of said third diode and an anode of which is connected to an anode of said fifth diode; and
a seventh switch connected between an interconnection point of the anodes of said fifth and sixth diodes and said second potential.

11. A drive circuit of a matrix type flat display device that applies a voltage to a capacitive load to be a display unit, said drive circuit comprising:
a first signal line connectable to said capacitive load;
a second signal line connectable to said capacitive load;
a first switch connected between said first signal line and a first potential;
a second switch connected between said first signal line and a second potential;
a capacitor connected between said first and second signal lines;
a third switch connected between said second signal line and said second potential; and
a coil circuit connected between at least one of said first and second signal lines and said second potential,
wherein at least one of said second switch and said third switch has a configuration in which two switches are connected in series, the switch being configured such that a cathode of a diode is connected to a collector of an IGBT and an anode of said diode is connected to an emitter of said IGBT, or a configuration in which a switch and an n-channel field-effect transistor are connected in series, the switch being configured such that a cathode of a diode is connected to a collector of an IGBT and an anode of said diode is connected to an emitter of said IGBT.

12. The drive circuit according to claim 11, wherein at least one of said second switch and said third switch has a configuration in which the collectors of said two IGBTs are connected in series or a configuration in which the collector of said IGBT and a drain of said n-channel field-effect transistor are connected in series.

13. The drive circuit according to claim 11, wherein at least one of said second switch and said third switch has a configuration in which the emitters of said two IGBTs are connected in series, or a configuration in which the emitter of said IGBT and a source of said n-channel field-effect transistor are connected in series.

14. The drive circuit according to claim 12, wherein said coil circuit includes:
a first diode an anode of which is connected to said second signal line; and
a first coil connected between a cathode of said first diode and said second potential; and
wherein said third switch has a configuration in which the collectors of said two IGBTs are connected in series, or a configuration in which the collector of said IGBT and the drain of said n-channel field-effect transistor are connected in series, and further includes a second diode an anode of which is connected to the cathode of said first diode and a cathode of which is connected to the collector of said IGBT.

15. The drive circuit according to claim 13, wherein said coil circuit includes:
a first diode a cathode of which is connected to said first signal line; and
a first coil connected between an anode of said first diode and said second potential, and
wherein said second switch has a configuration in which the collectors of said two IGBT are connected in series, or a configuration in which the collector of said IGBT and the drain of said n-channel field-effect transistor are connected in series, and further includes a second diode a cathode of which is connected to the anode of said first diode and an anode of which is connected to the emitter of said IGBT.

16. The drive circuit according to claim 12, wherein said coil circuit includes:
a first diode a cathode of which is connected to said first signal line;
a first coil connected between an anode of said first diode and said second potential; and further
a fourth switch connected between the anode of said first diode and said second potential.

17. The drive circuit according to claim 13, wherein said coil circuit includes:
a first diode an anode of which is connected to said second signal line;
a first coil connected between a cathode of said first diode and said second potential; and further
a fourth switch connected between the cathode of said first diode and said second potential.

18. A plasma display device comprising:
the drive circuit according to claim 11; and
a plasma display panel having said capacitive load.

19. A drive circuit of a matrix type flat display device that applies a voltage to first and second capacitive loads to be a display unit, said drive circuit comprising:
a first signal line connectable to said first capacitive load;
a second signal line connectable to said first capacitive load;
a first switch connected between said first signal line and a first potential;
a second switch connected between said first signal line and a second potential and having a configuration in which two switches are connected in series, the switch being configured such that a cathode of a diode is connected to a collector of an IGBT and an anode of said diode is connected to an emitter of said IGBT, or a configuration in which a switch and an n-channel field-effect transistor are connected in series, the switch being configured such that a cathode of a diode is connected to a collector of an IGBT and an anode of said diode is connected to an emitter of said IGBT;
a first capacitor connected between said first and second signal lines;
a third switch connected between said second signal line and said second potential and having a configuration in which two switches are connected in series, the switch being configured such that a cathode of a diode is connected to a collector of an IGBT and an anode of said diode is connected to an emitter of said IGBT, or a configuration in which a switch and an n-channel field-effect transistor are connected in series, the switch being configured such that a cathode of a diode is connected to the collector of an IGBT and an anode of said diode is connected to the emitter of said IGBT;
a first diode a cathode of which is connected to said first signal line;
a first coil connected between an anode of said first diode and said second potential;
a second diode an anode of which is connected to said second signal line;
a second coil connected between a cathode of said second diode and said second potential;
a third signal line connectable to said second capacitive load;
a fourth signal line connectable to said second capacitive load;
a fourth switch connected between said third signal line and said first potential;
a fifth switch connected between said third signal line and said second potential and having a configuration in which two switches are connected in series, the switch being configured such that a cathode of a diode is connected to a collector of an IGBT and an anode of said diode is connected to an emitter of said IGBT or a configuration in which a switch and an n-channel field-effect transistor are connected in series, the switch being configured such that a cathode of a diode is connected to a collector of an IGBT and an anode of said diode is connected to an emitter of said IGBT;
a second capacitor connected between said third and fourth signal lines;
a sixth switch connected between said fourth signal line and said second potential and having a configuration in which two switches are connected in series, the switch being configured such that a cathode of a diode is connected to a collector of an IGBT and an anode of said diode is connected to an emitter of said IGBT, or a configuration in which a switch and an n-channel field-effect transistor are connected in series, the switch being configured such that a cathode of a diode is connected to a collector of an IGBT and an anode of said diode is connected to an emitter of said IGBT;
a third diode a cathode of which is connected to said third signal line;
a third coil connected between an anode of said third diode and said second potential;
a fourth diode an anode of which is connected to said fourth signal line; and
a fourth coil connected between a cathode of said fourth diode and said second potential.

20. The drive circuit according to claim 19, further comprising:
a fifth diode a cathode of which is connected to the anode of said first diode;
a sixth diode a cathode of which is connected to the anode of said third diode and an anode of which is connected to an anode of said fifth diode; and
a seventh switch connected between an interconnection point of the anodes of said fifth and sixth diodes and said second potential.
